(19) United States
(12) Patent Application Publication
(10) Pub. No.: US 2020/0111315 A1
(43) Pub. Date: Apr. 9, 2020

(54) SLOT MACHINE SYSTEM WITH BANKING FEATURE

(71) Applicant: Fernando DiCarlo, Woodbridge (CA)

(72) Inventor: Fernando DiCarlo, Woodbridge (CA)

(21) Appl. No.: 16/154,084

(22) Filed: Oct. 8, 2018

(51) Int. Cl. G07F 17/32; G07F 17/34

(52) U.S. Cl. CPC G07F 17/3262; G07F 17/3209; G07F 17/34; G07F 17/3213

(57) ABSTRACT

An electronic system and method to implement a slot machine gaming system which enables a player to bank their winnings. Credits in the bank can be risked on each spin and the credits in the bank could be all lost or multiplied depending on an outcome of the spin. The player has the option to take all credits in the bank and transfer them to the credit meter where they would be safe and would not be risked on a subsequent spin.

### BACKGROUND OF THE INVENTION

### Field of the Invention

The present general inventive concept is directed to a method, apparatus, and computer readable storage medium directed to an entertainment system enabling players to bank wins instead of immediately collecting them.

### Description of the Related Art

Electronic games are a huge industry in the United States and throughout the world. What is needed is a new casino game that will be profitable for the house and exciting and enjoyable for players.

### SUMMARY OF THE INVENTION

It is an aspect of the present invention to provide an electronic interactive and entertaining game.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing of different hardware that the methods herein can be played on, according to an embodiment;

FIG. 2 is a flowchart illustrating a method of how a prior art slot machine operates.

FIG. 3 is a block diagram of a network utilized to implement networking personal computing devices, according to an embodiment;

FIG. 4 is a drawing of a five reel slot machine display, according to an embodiment.

FIG. 5 is a drawing of the five reel slot machine during the reel spin, according to an embodiment.

FIG. 6 is a drawing of the five reel slot machine after it stops spinning, according to an embodiment;

FIG. 7 is a drawing of an example payline structure, according to an embodiment;

FIG. 8 is a drawing of a three reel slot machine, according to an embodiment.

FIG. 9 is a drawing of a one reel slot machine, according to an embodiment;

FIG. 10 is a flowchart illustrating an exemplary method of implementing a slot machine with a banking feature, according to an embodiment;

FIG. 11 is a drawing of the three reel slot game of FIG. 8 after the reels are spun, according to an embodiment;

FIG. 12 is a drawing of the three reel slot game of FIG. 11 after the reels are stopped, according to an embodiment;

FIG. 13 is a drawing of the three reel slot game of FIG. 12 after the take button was pressed, according to an embodiment;

FIG. 14 is a drawing of the three reel slot game of FIG. 12 after the spin button is pressed, according to an embodiment;

FIG. 15 is a drawing of the three reel slot game of FIG. 14, after the reels stop, according to an embodiment;

FIG. 16 is a block diagram illustrating exemplary hardware that can be used to implement an electronic version of the methods described herein; and

FIG. 17 is a block diagram illustrating an exemplary network configuration to implement a player playing an online version of the methods described herein.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a slot machine game with a banking function. As known in the art, when a player plays a slot machine and wins, the payout goes directly to the player's credit meter. In the banking function of the present inventive concept, the payout can go to a player bank. The player bank is a stored quantity which is at risk on every spin of the slot machine, as the player bank can be increased or decreased upon each spin. At any time, the player could convert (transfer) all credits in the bank to the credit meter (e.g., if the bank has 10 credits and the credit meter has 100 credits then the credit meter would have 110 credits and the bank would have 0 credits). Certain symbols and/or combinations on the slot machine paylines after a spin could result in the bank being increased (e.g., multiplied by a multiplier) or decreased (e.g., busted which means it goes to zero). In this way, the player gets a more exciting game because the player can risk a lot more than just the wager used to make the spin.

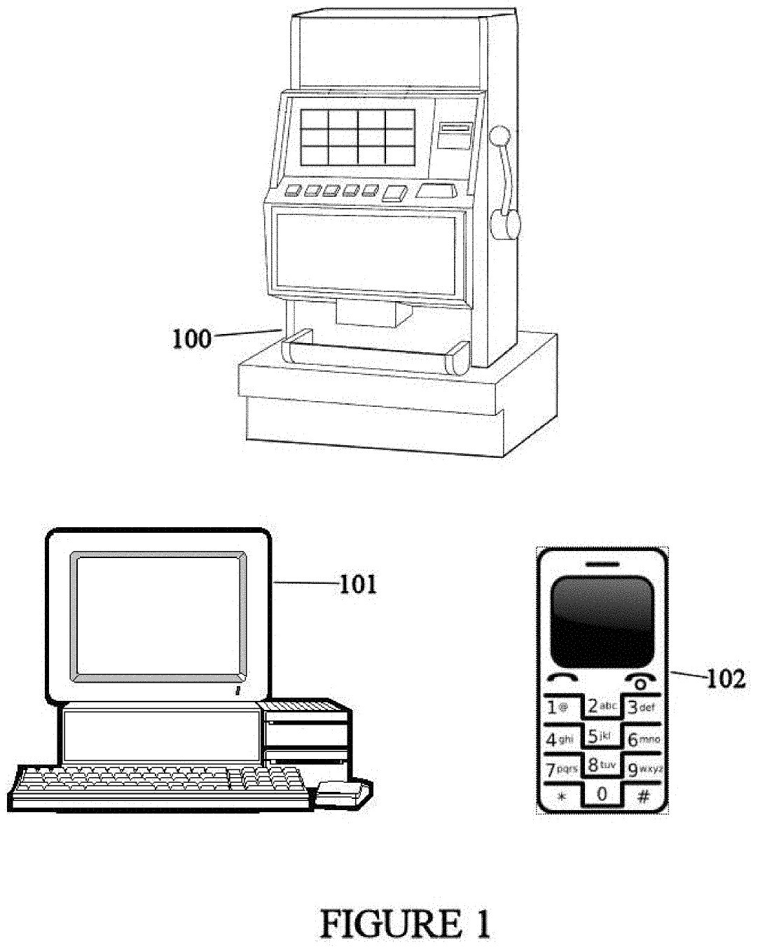

FIG. 1 is a drawing of different hardware that the methods herein can be played on, according to an embodiment.

The game described herein can be played by players on a typical electronic gaming machine (e.g., slot machine), a personal computer (or laptop) 101, or a cell (mobile) phone 102. Each of these devices would be connected to a network which would be connected to a server 500. The connection can be via a physical LAN, wireless connection (e.g., WIFI, Bluetooth, etc.) simple cables, etc.

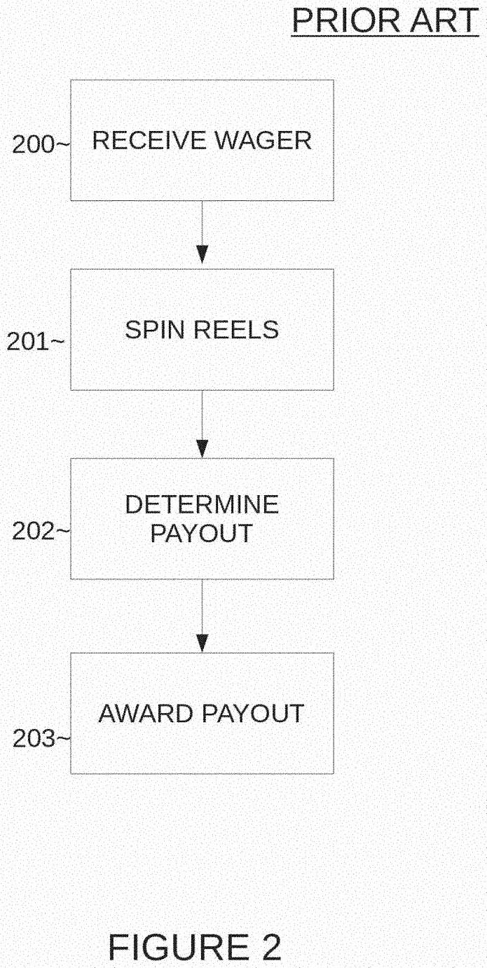

FIG. 2 is a flowchart illustrating a method of how a prior art slot machine operates. There are many types of slot machine games (e.g., five reel, three reel, one reel, etc.) and they all generally operate in the same manner.

Before the player can start making wagers (and playing), the player must fund the machine with real money (e.g., cash). For example, the player can deposit cash (e.g., a $10 bill) which would credit the machine/account with $10 in credits (if credits are $1 per credit then this would translate to 10 credits). The machine/account can also be funded by other mechanisms as well, such as an electronic funds transfer, credit card payment, etc.

In operation 200, the slot machine game receives a wager from the player. Each machine keeps a balance of credits which are used to make wagers. Each spin (play) of the game costs a particular amount of credits (e.g., 1 credit, 10 credits, etc.) The player would indicate that he/she has placed his wager by pressing a button on the game (e.g. virtual or physical) which would cause the reels to spin (in operation 201). The player may also choose how many paylines to play (more paylines would typically cost more credits). A payline is a set of locations on each reel that, when combined, are compared to a paytable to determine whether a spin is a winning spin or not and if it is a winning spin what the payout would be. The wager is received by deducting the wager amount (typically in credits) from a credit meter (which displays the entire amount of credits the machine currently possesses).

From operation 200, the method proceeds to operation 201, which spins the reels. In a physical slot machine game, the reels will be physical reels which physically spin, while in a virtual slot machine the reels do not physically exist and are displayed on an electronic output device (e.g., LCD) and are spun using computer animation. Each reel will stop on a random symbol selected by a random number generator. Each reel has aa set of symbols according to a reel mapping which is typically a linear set of symbols that is “wrapped” around the reel. The reel mapping is typically predetermined for each game. In an embodiment all reels can have the same mapping but in another embodiment reels can have different mappings.

From operation 201, the method proceeds to operation 202, which determines a payout based on the symbols displayed on the slot machine. One or more paylines will be active based upon the game rules and what paylines the player chose to bet in operation 200. For all of the active paylines, a respective payline award is determined based on comparing the symbols that fall into each payline to a paytable. All of the respective payline awards are added together to determine the payout for the spin.

From operation 202, the method proceeds to operation 203, which awards the payout to the player. This is typically accomplished by increasing the credit meter by the amount of the payout. If the payout is zero, then the spin is not a winning spin (it is a losing spin) and there is no payout (this can also be considered a payout of zero).

From operation 203, the player can then play a new game as the method can return to operation 200. At any time the player can cash out the credits on the credit meter by pressing a button and the player could receive all of the machine's credits (e.g., as a cashless voucher, in coins/currency, as an electronic transfer to the player's account, etc.)

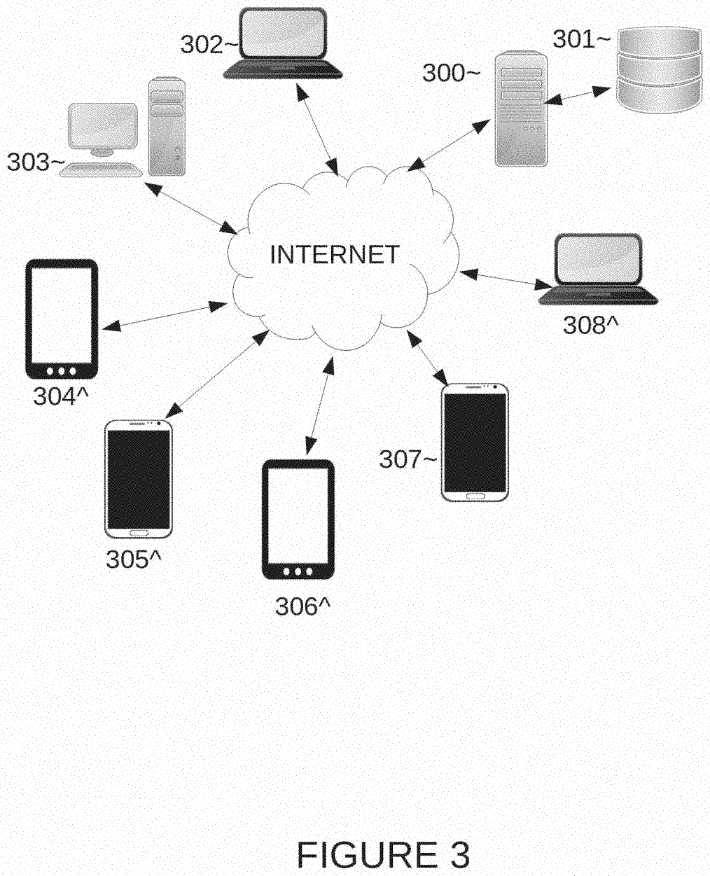

FIG. 3 is a block diagram of a network utilized to implement networking personal computing devices, according to an embodiment.

In addition to being played on physical slot machines inside a physical casino, the game can also be offered entirely online and players can use their personal computing devices (e.g., personal computer, laptop, tablets, cell phones, etc.) to connect to server 300 (which serves as server 300 and implements (causes) games on all of the personal computing devices). Server 300 can store all data needed internally or any such data can be stored on an external database 301 which connects and communicates with server 300. Server 300 contains a computer readable storage medium which is programmed to implement (cause) all of the methods/features described herein to be implemented on the personal computing devices of the remote players.

Shown are seven remote players 302, 303, 304, 305, 306, 307, 308, which are in all different physical locations and connect to the server 300 via the internet. Each of the remote players can connect using a web browser and/or by installing and running an app on their personal computing device which is programmed to connect to the server 300 and implement all of the methods described herein.

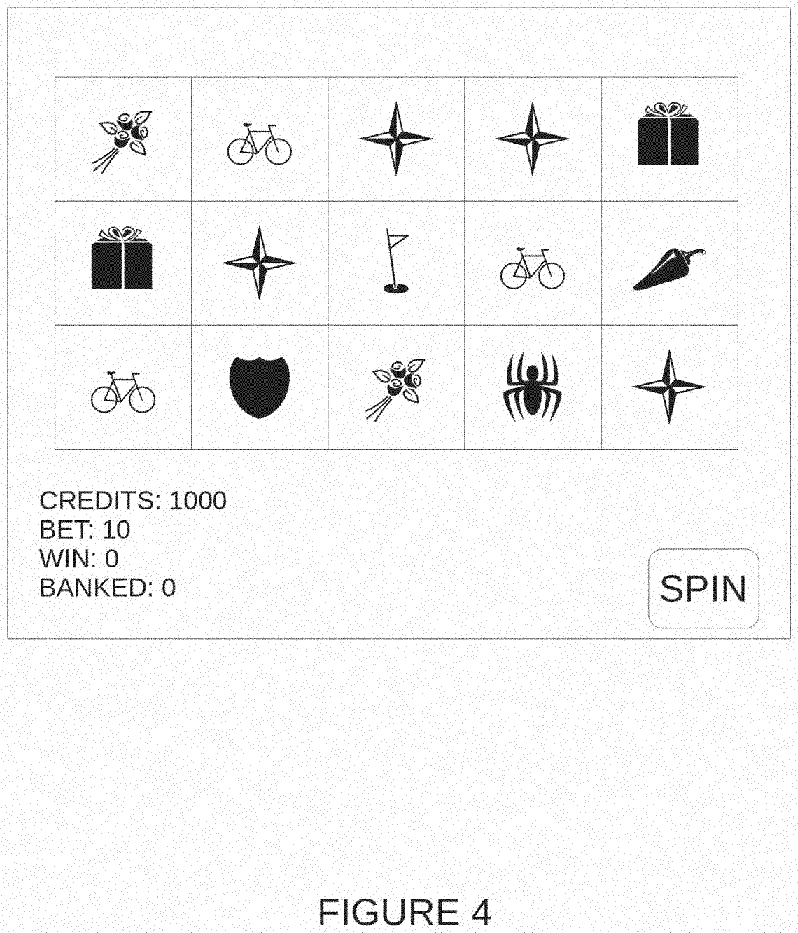

FIG. 4 is a drawing of a five reel slot machine display, according to an embodiment.

The player can indicate an amount to wager (bet) but this amount is not deducted from the credit meter (which currently reads 1000) until the player presses the “spin” button which deducts the wager amount and initiates the spin.

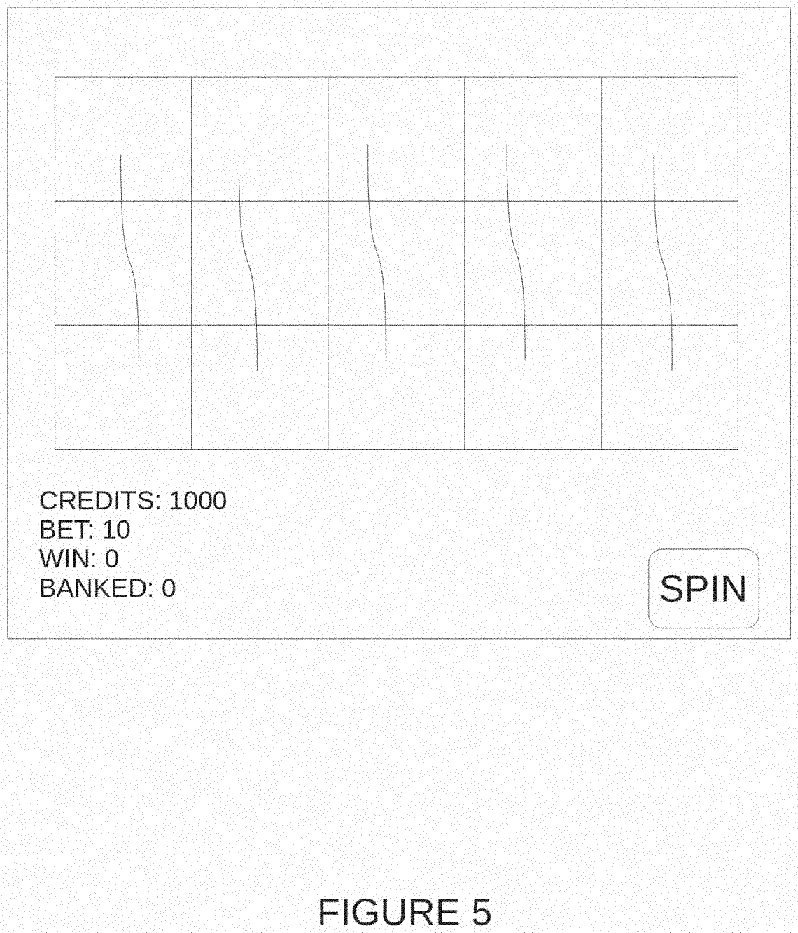

FIG. 5 is a drawing of the five reel slot machine during the reel spin, according to an embodiment.

All of the reels are shown with animated spinning reels. The reels will then stop one by one (typically from left to right) to their final position for the spin. Pressing the spin button while the reels are spinning typically will not have any function.

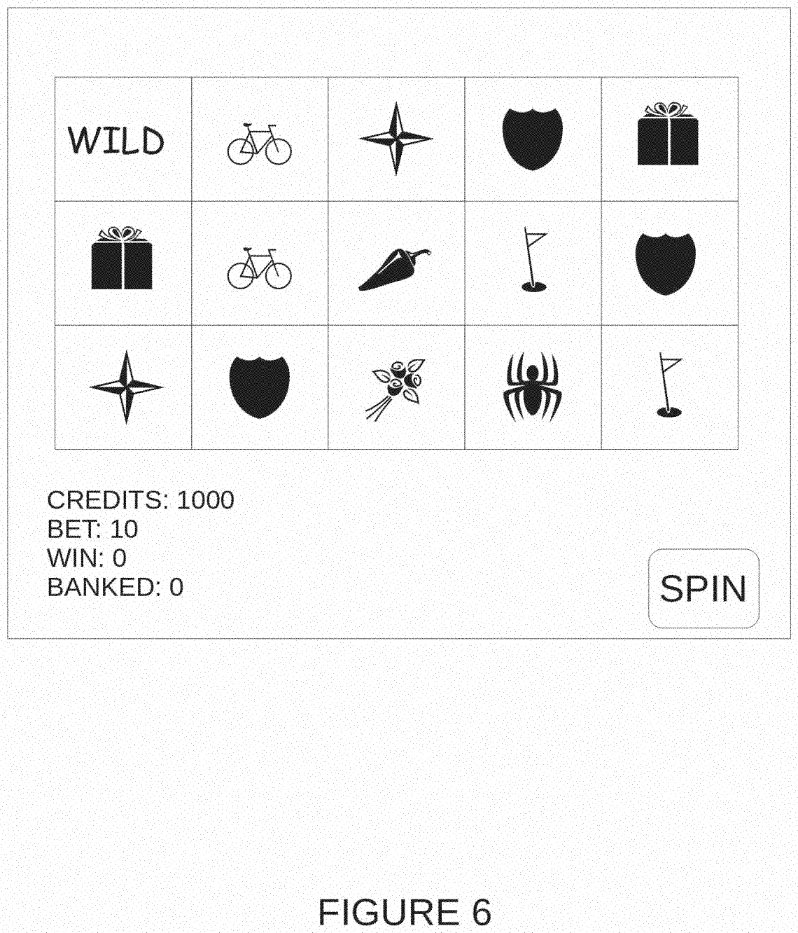

FIG. 6 is a drawing of the five reel slot machine after it stops spinning, according to an embodiment.

Once the reels stop spinning, the slot machine shows symbols in all of the positions on the grid. Now that the reels are stopped, the “spin” button would now function to spin the reels again (after deducing another wager). For all of the active paylines, the symbols on those paylines are compared to a paytable to determine an award (if any) for each payline. All of the awards for all paylines are awarded to the player as a payout. In an embodiment, the payout can be automatically added to the bank (not the credit meter), wherein the player can then choose if he/she wants to transfer all of the credits in the bank to the credit meter (“take”) or keep the credits in the bank.

A sample paytable for a five reel is illustrated in Table I. Of course, this is just an example paytable, and many other paytables can be used as well.

TABLE I

| | 5 | 4 | 3 | 2 | 1 |
|---|---|---|---|---|---|
| Symbol | symbols | symbols | symbols | symbols | symbol |
| [symbol] | 1,000:1 | 250:1 | 100:1 | 50:1 | 0 |
| [symbol] | 500:1 | 300:1 | 90:1 | 0 | 0 |
| [symbol] | 250:1 | 100:1 | 50:1 | 0 | 0 |
| [symbol] | 100:1 | 50:1 | 25:1 | 0 | 0 |
| [symbol] | 75:1 | 40:1 | 20:1 | 0 | 0 |
| [symbol] | 50:1 | 30:1 | 15:1 | 0 | 0 |
| [symbol] | 40:1 | 25:1 | 10:1 | 0 | 0 |
| [symbol] | 25:1 | 10:1 | 0 | 0 | 0 |
| BUST! | n/a | n/a | n/a | n/a | bank = 0 |
| X2 | n/a | n/a | n/a | n/a | bank = bank*2 |
| X3 | n/a | n/a | n/a | n/a | bank = bank*3 |
| X5 | n/a | n/a | n/a | n/a | bank = bank*5 |
| X10 | n/a | n/a | n/a | n/a | bank = bank*10 |

The sample paytable in Table I can be read as follows. For each symbol, there is a different payout for a different quantity of those symbols. For example, five “present” symbols on a payline would pay 1,000:1 for the wager amount for that payline. Each payline can have its own wager amount, for example the player can play 9 paylines and wager $0.10 on each payline for a total wager of $0.90 per spin. While wagers are made in credits, typically credits are directly exchangeable for a currency amount (e.g., 1 credit equals 1 cent). As another example, four “spider” symbols on a payline would pay 300:1 (thus, if 10 cents were bet on that payline with the four spiders, then the payline would have an award of $30.00). Note that typically, symbols on a payline would only count if they appear on the payline consecutively from left to right, while in another embodiment it does not matter in what order the symbols appear on the payline. Note that a paytable is typically generated by the game designers along with the reel mappings (each reel has a strip of symbols) so that the overall game in the long run has an overall return to player (RTP) in an acceptable casino range (e.g., 90% to 99%). Combinations that do not appear on the paytable (Table I) are not winners (payout of zero which is a loser). If a player makes a loser and all paylines are losers, then the payout is zero but the player of course has already made his wager which is lost.

Note that in Table I, “n/a” means that it is not possible for that symbol to appear that many times. For example, in this example the “BUST!” symbol can only appear one time because it is only present on one reel (it can appear on the reel strip more than once so long as two such symbols are not vertically adjacent to each other so that it is not possible for more than one such symbol to appear on the display at any given time). Typically, the right reel would contain the “bank operation” symbols, although they can appear on any of the reels. A “bank operation” symbol is a symbol which triggers a bank operation, which changes the value of the bank in a different way than just adding a newly won payout to it (e.g., bank operations can multiply the bank (“X2”, “X3”, etc.), and reset the bank quantity to zero (“BUST!”). Note the multiplier in a bank operation cannot be zero and must be positive and are typically positive integers.

If an award is won when a bank operation is triggered the award(s) would be awarded first in a payout before the bank operation would be applied. For example, if a spin would award the player 100 credits and also contains a bank operation to double the bank, the bank would be increased by 100 credits and then the bank would be doubled. If a spin would award the player 50 credits and also contains a bank operation to bust the bunk (reset it to zero), the bank would be reset to zero and the player would not receive the 50 credits. Note that in an embodiment, bank operations can also be triggered by combinations of more than one symbol as well, for example, 3 spiders can trigger a bust, 2 spiders can trigger a double bank, 1 spider can trigger a triple bank, etc.

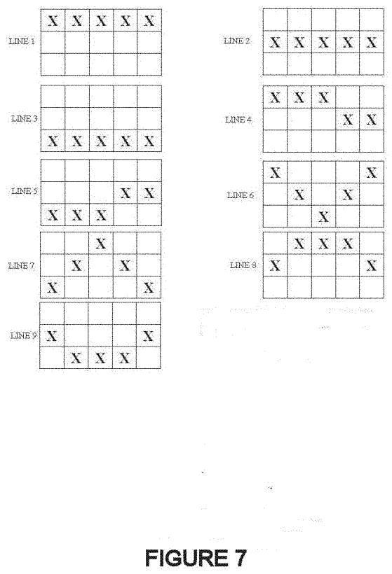

FIG. 7 is a drawing of an example payline structure, according to an embodiment. Shown in FIG. 7 are paylines for a five reel slot machine game.

Note that when the symbols stop spinning, there are discrete paylines of which the respective symbols are combined to compare to the paytable. In one embodiment, all possible paylines are live, meaning 3\hat{ }5=243 paylines (this is all possible combinations of symbols using one symbol in each column from left to right). In another embodiment, there are a smaller number of predefined paylines. For example, FIG. 7 shows a game with only nine paylines with the ‘X’ symbol designated which particular location in the grid is used for each payline. Typically, all paylines are automatically active (able to win awards for combinations appearing therein) for every spin.

Also used in a slot machine game is a paytable which shows winning combinations and the amount of win credits that would be awarded for each such winning combination. Each payline is checked for such winning combinations, and so more than one payline can have a winning combination (each and every winning combination on each payline is awarded). Note that all combinations not shown in the paytable are losers (do not pay any award).

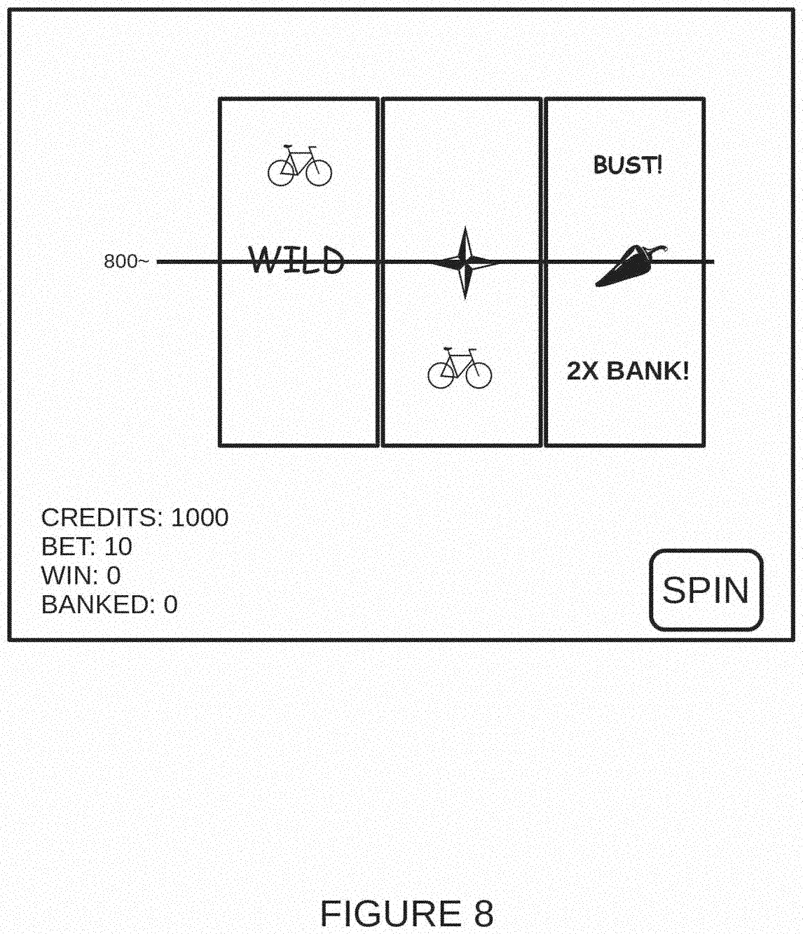

FIG. 8 is a drawing of a three reel slot machine, according to an embodiment.

Instead of the five reel slot machine game as shown in FIG. 4, the methods described herein can be applied to a three reel game. The game operates as described herein but utilizes three reels instead of 5. Note that in this example, there is only one payline 800 running horizontally through the center of the reels, although three reel games can also have more than one payline as well. In the example shown, the only payline consists of the three symbols “wild”, “star”, and “pepper.” Table II illustrates on example paytable for a three reel game.

TABLE II

| Combination | Payout/Bank Operation |
|---|---|
| WILD WILD WILD | 1000:1 |
| [symbol] [symbol] [symbol] | 100:1 |
| [symbol] [symbol] [symbol] | 10:1 |
| [symbol] [symbol] [symbol] | 2:1 |
| any BUST! | bank = 0 |
| any X2 | bank = bank*2 |
| any X3 | bank = bank*3 |
| any X5 | bank = bank*5 |
| any X10 | bank = bank*10 |

In Table II, all combinations that are not listed have an award/payout of zero. The “Wild” symbol substitutes for any other symbol and will automatically substitute for the symbol which would provide the player the highest payout (although wild symbols will not substitute for any bank operation symbols (e.g., “X2”, X10”, “BUST”, etc.)

In this example game, the bank operation symbols are only present on the third reel, thus it would not be possible to get more than one bank operation symbol on the payline 800 on a spin. In the example game illustrated in FIG. 8, if a symbol is not present on a location on the reel it is a blank symbol (blank symbols are commonly scattered through the reel strip). Thus, in Table II, if any of the bank operation symbols are present on the payline it will trigger that respective bank operation. In this example it would not be possible for more than one bank operation symbol to appear on the payline because the paying operation symbols are only present on one reel (e.g., the last reel).

Note that awards can be grouped into two categories, static awards and dynamic awards. A static award is an award from the paytable which has a predetermined (static) payout, for example three peppers pays 100:1. The static awards would be the same regardless of how many credits are currently in the bank (banked). Static awards are computed by determined the payout of the particular combination (using the paytable) achieved multiplied by the bet (wager). A dynamic award is an award that is dependent upon how many credits are in the bank (banked). For example, X2 doubles the amount of credits in the bank (banked). Without knowing how many credits are in the bank, there would be know way to know how many credits a dynamic award would result it. Dynamic awards would include x2, x3, x5, x10, bust, etc. Bust is included as a dynamic award because bust is a “negative payout” which takes from the player the amount in the bank (banked). Thus, without knowing what is in the bank it could not be determined how many credits the player would lose by getting the “bust” bank operation. The amount of the bet (wager) does not make any difference with regard to a dynamic award.

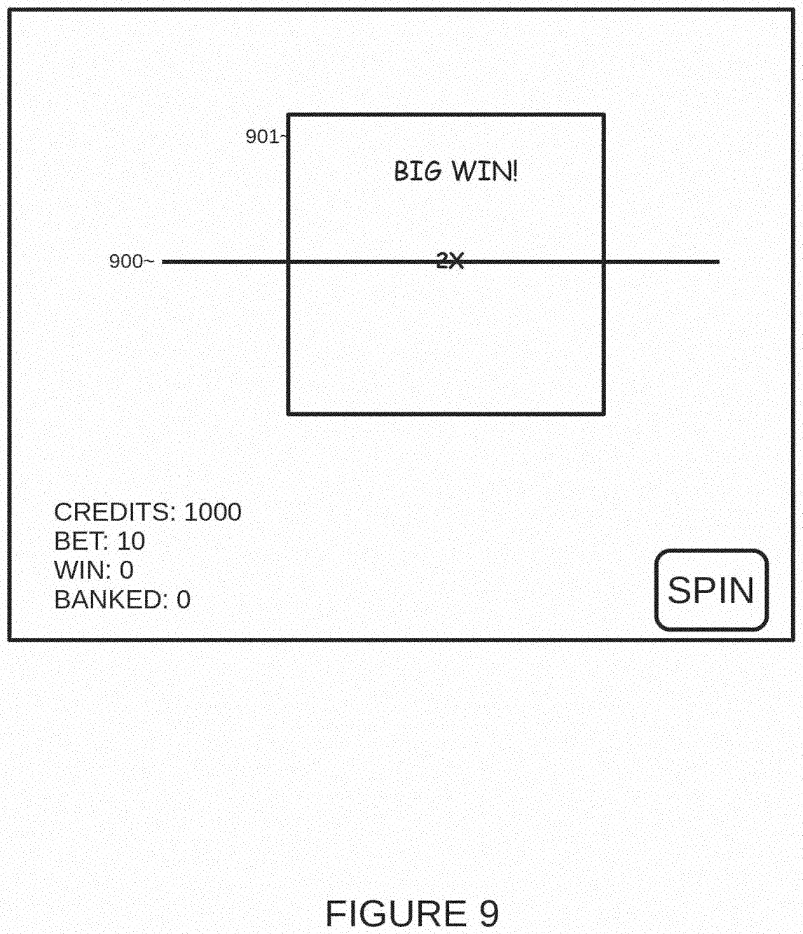

FIG. 9 is a drawing of a one reel slot machine, according to an embodiment.

The methods described herein can also be applied to a one reel game. A spin of a one reel game results in a single symbol (a symbol can include a blank symbol) which determines what award/result (if any) the player gets.

Table III below is an example paytable for a one reel slot machine game.

TABLE III

| Symbol | payout/bank operation |
|---|---|
| Super big win | 20:1 |
| Big win | 10:1 |
| Win | 2:1 |
| X2 | bank = bank*2 |
| X3 | bank = bank*3 |
| X5 | bank = bank*5 |
| Bust | bank = 0 |

In the paytable illustrated in Table III, bank operations consist of X2, X3, X5, and bust. X2 means the bank is doubled, X3 means the bank is tripled, X5 means the bank is multiplied by five, and bust means the bank is set to zero (the player loses all credits in the bank).

In FIG. 9, the symbol on the payline 900 is the “X2” symbol meaning the credit amount in the bank is doubled. In this example, since the bank has zero credits, nothing happens to the bank.

Note that difference between the bank and the credit meter, the credit meter is only deducted when the player makes a wager (which comes out of the credit meter) but otherwise the credits in the credit meter are safe and can never be lost during the play of the game (other than the initial bet amount). On the other hand, the credits in the bank can be lost on each spin (if the “bust” bank operation is triggered on a spin). Thus, a player who wants to “play it safe” would frequently utilize the “take” button to transfer the credits from the bank into the credit meter. On the other hand, a player who likes taking more risks may wish to seldom use the “take” button in the hope of growing the bank to a large amount. The player would have to eventually push the “take” button in order to be able to cash out the credit in the bank, as the credits in the bank cannot be cashed out (but the credits in the credit meter can be).

All payouts herein are based upon the bet (wager amount). For example if the bet on a game/payline is $1 and the payout on a paytable is 10:1, that means the payout made to the player would be $10. Table IV below illustrates an example reel mapping for a single reel for the single reel game illustrated in Table III. It is noted that this is just one example and no representation is made that this game (reel mapping and paytable) would result in a RTP in an acceptable range.

TABLE IV

| Reel position | symbol |
|---|---|
| 1 | blank |
| 2 | blank |
| 3 | win |
| 4 | blank |
| 5 | blank |
| 6 | big win |
| 7 | double bank |
| 8 | blank |
| 9 | blank |
| 10 | super big win |
| 11 | blank |
| 12 | X2 |
| 13 | blank |
| 14 | blank |
| 15 | big win |
| 16 | blank |
| 17 | blank |
| 18 | X3 |
| 19 | blank |
| 20 | win |
| 21 | win |
| 22 | blank |
| 23 | blank |
| 24 | X5 |
| 25 | blank |
| 26 | bust |
| 27 | X2 |
| 28 | blank |
| 29 | big win |
| 30 | bust |
| 31 | blank |
| 32 | bust |

Note that each reel spun would stop on a random symbol with each symbol having an equal probability of stopping. In another embodiment, weighted reels could be used in which a reel would be more likely to stop on certain symbols than other symbols.

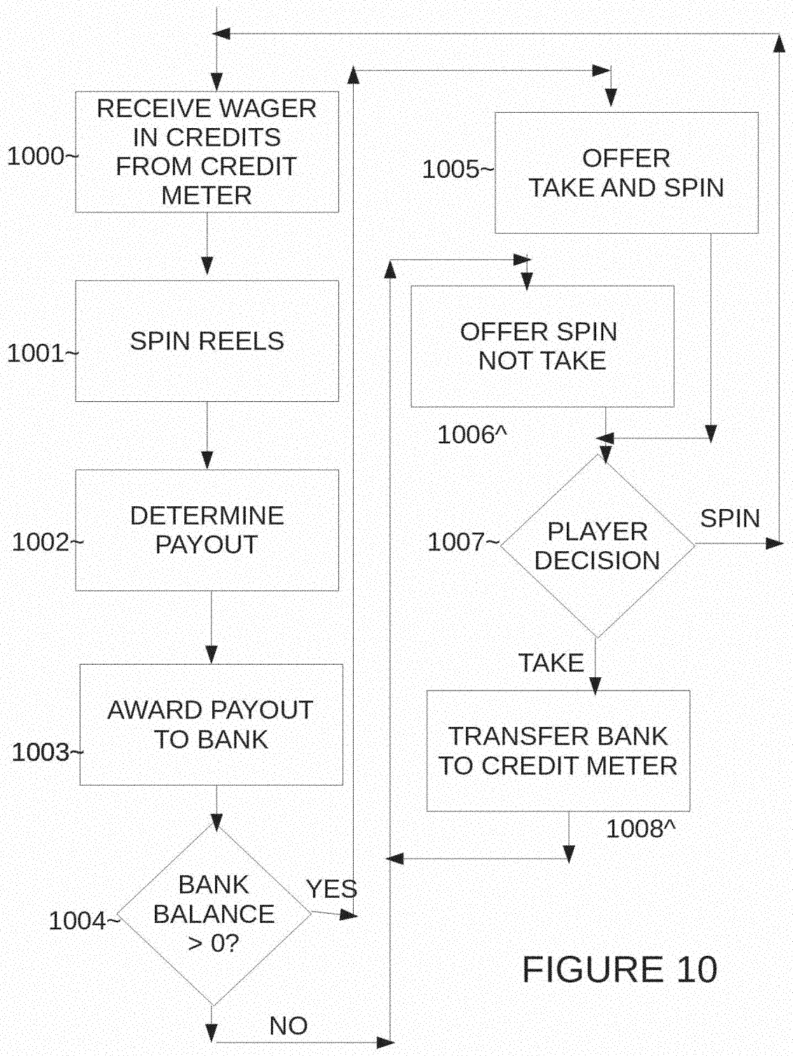

FIG. 10 is a flowchart illustrating an exemplary method of implementing a slot machine with a banking feature, according to an embodiment.

Before reaching operation 1000, the player would fund the game (as described herein) so that the machine/game has credits the player can play with. Typically, when a player walks up to a new machine (before playing it), the machine would have zero credits on the credit meter as the player would need to fund the game. Also, when the player walks up to a new machine (before playing it), typically the bank would have zero credits on it (because presumably any player who previously played the machine before would have cashed out the bank and the credit meter).

The method can begin with operation 1000 in which the player makes a wager in credits in order to make a spin. This can be done by indicating how much to bet and pressing a “spin” button to activate operation 1000. The amount of the bet (“wager” is synonymous with “bet”) is deducted from the player's credit mater. Upon pressing the “spin” button, the method would proceed to operation 1000 and then 1001. In other words, by pressing the spin button, the wager is deducted from the credit mater and the spinning begins. Thus, operation 1000 is not executed until the “spin” button is pressed.

From operation 1001, the method proceeds to operation 1002, which determines the payout for the last spin. This can be done as described herein and known in the art. After the spin, the reels display a combination of symbols. Each payline is compared to the paytable to determine a payout/result for that payline, and all paylines are awarded to the player. Note that in an embodiment, a spin can trigger an optional bonus/skill round. A bonus/skill round is a game that typically does not involve spinning reels that is played after the spin which may involve some type of skill on the part of the player, such as stopping a symbol at a particular time, selecting random objects, etc. If the spin triggers a bonus round (or a skill round, etc.) which is used to determine the payout for the spin, then that bonus round would be initiated and completed in operation 1002 so the payout that is determined incorporates the outcome of the bonus round. The bonus/skill round would modify the payout already determined based upon the spin before the bonus/skill round has started. As one example, the payout (based on the spin alone) can be determined to be 15 credits, but then a bonus round is implemented which multiples the payout by 2, thereby resulting in a payout of 30 credits (which is then passed to operation 1003). The bonus round can modify the payout by multiplying it, adding additional credits, etc.

From operation 1002, the method proceeds to operation 1003, which awards the payout from operation 1002 to the bank. The bank is a quantity of credits kept separate from the credit meter. The award can be a discrete quantity of credits and/or can also be a bank operation. A bank operation is a result in which the bank is multiplied or busted. Some combinations on the paytable can result in the bank being multiplied by a particular multiplier (e.g., X2, X3, 5, X10, or any other multiplier) which would result in the amount of credits in the bank being multiplied by this amount. Another bank operation can be a “bust” in which the bank is reset to zero, meaning the player has lost all credits in the bank.

From operation 1003, the method proceeds to operation 1004, which determines whether the balance of credits in the bank is greater than 0. If the balance of credits in the bank is greater than zero, then the method proceeds to operation 1005. If the balance of credits in the bank is not greater than zero, then the method proceeds to operation 1006.

In operation 1005, the game offers the player the option to both “take” and “spin.” Take means the player can convert (transfer) all credits in the bank to the credit meter. Spin means the player would play a new game by making another wager and spinning the reels. From operation 1005, the method proceeds to operation 1007.

In operation 1008 the player is offered the ability to spin again but is not offered the option to take. There is nothing in the bank so it would not be possible to convert the credits from the bank into the credit mater. From operation 1006, the method proceeds to operation 1007.

In operation 1007, the player makes a decision as to what action to take, which includes being able to spin (and possibly take). If take is not offered (the method arrived at operation 1007 from operation 1006) then a “take” button would be deactivated (e.g., greyed out and would have no function if pressed). If take is offered the method arrived at operation 1007 from operation 1005), then the take button is active (not greyed out and can be pressed).

In operation, if the player presses the spin button, then the method returns to operation 1000 and the player can play again. By pressing the “spin” button the wager is deducted from the credit meter (operation 1000) and the reels would spin (operation 1001).

If in operation 1007, the player choses to “take” (by pressing a take button), then the method proceeds to operation 1008. In operation 1008, the entire credit balance in the bank is added to the credit balance in the credit meter, and the credit balance in the bank is then reset to zero. Essentially, what has happened is the player has decided to “take” or “keep” the credits in the bank and not gamble with them anymore. From operation 1008, the method returns to operation 1006, in which the player can press “spin” to play again.

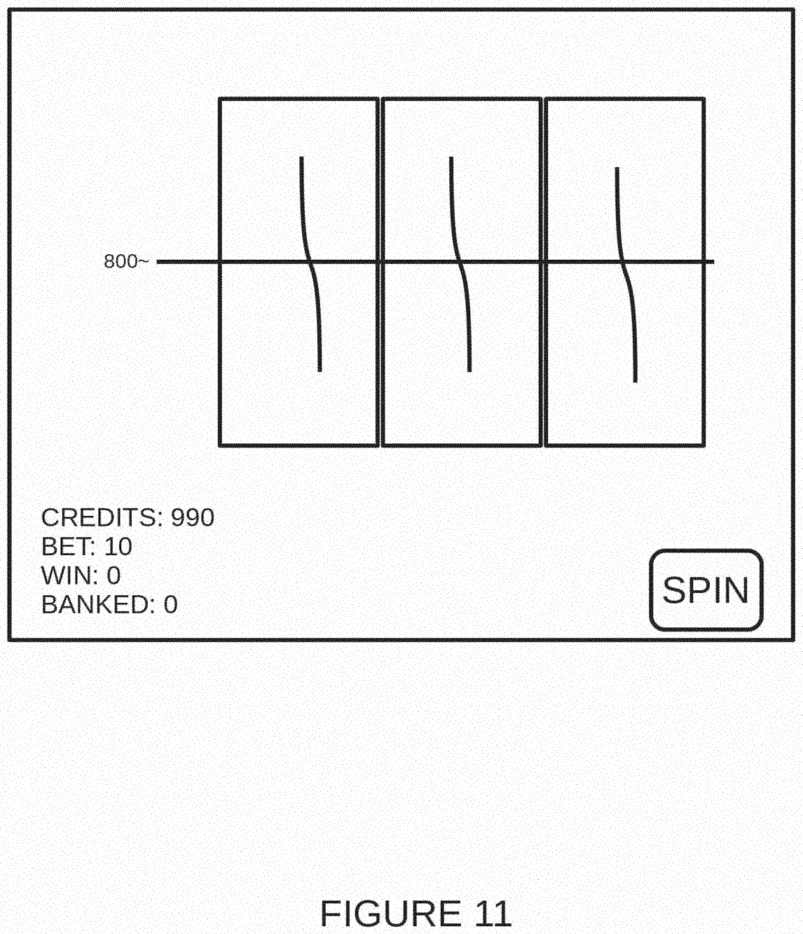

FIG. 11 is a drawing of the three reel slot game of FIG. 8 after the reels are spun, according to an embodiment.

The spin button was pressed (in FIG. 8) and the three reels are spun. Note that the credit meter has dropped by 10 credits (from 1,000 credits to 990 credits) because the wager amount is 10 credits. Each reel will stop on a random symbol.

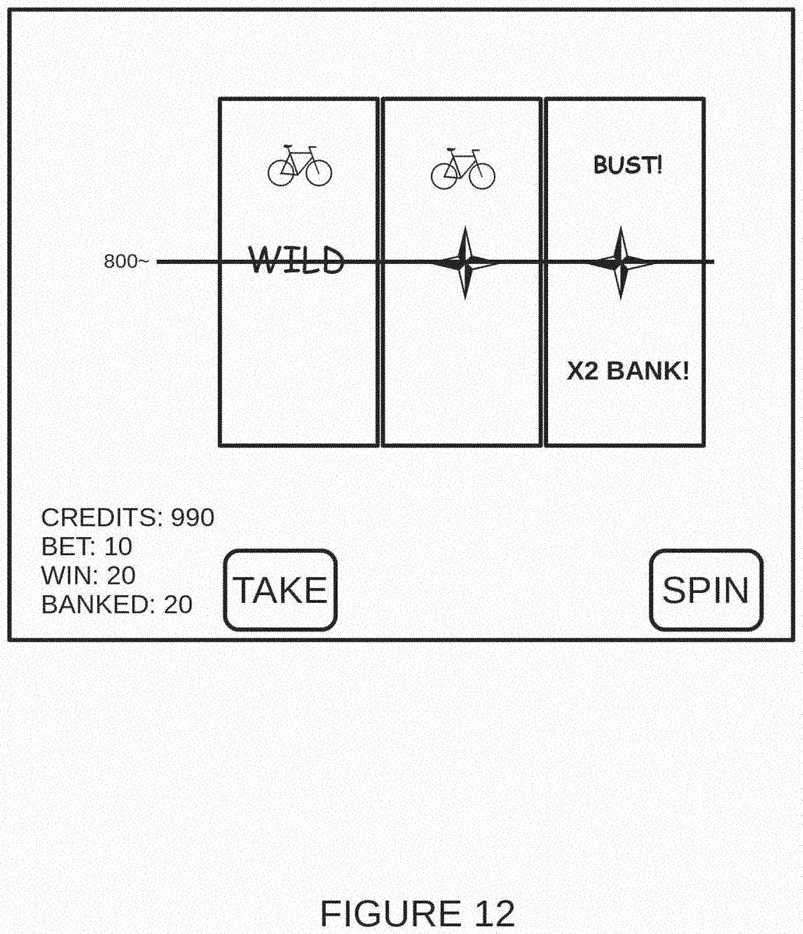

FIG. 12 is a drawing of the three reel slot game of FIG. 11 after the reels are stopped, according to an embodiment.

After FIG. 12, the reels stop. The combination on the payline 800 is wild/star/star, which according to the paytable in Table II pays 2:1. Since 10 credits were bet, the 2:1 payout is 20 credits, which is added to the “banked” total (the bank credit amount). Thus, the player now has 20 credits banked. Note the “take” button is now active. The player can choose to press the “take” button and take the banked amount (into the credit meter) or press the “spin” button and continue to play risking the banked amount (currently 20 credits).

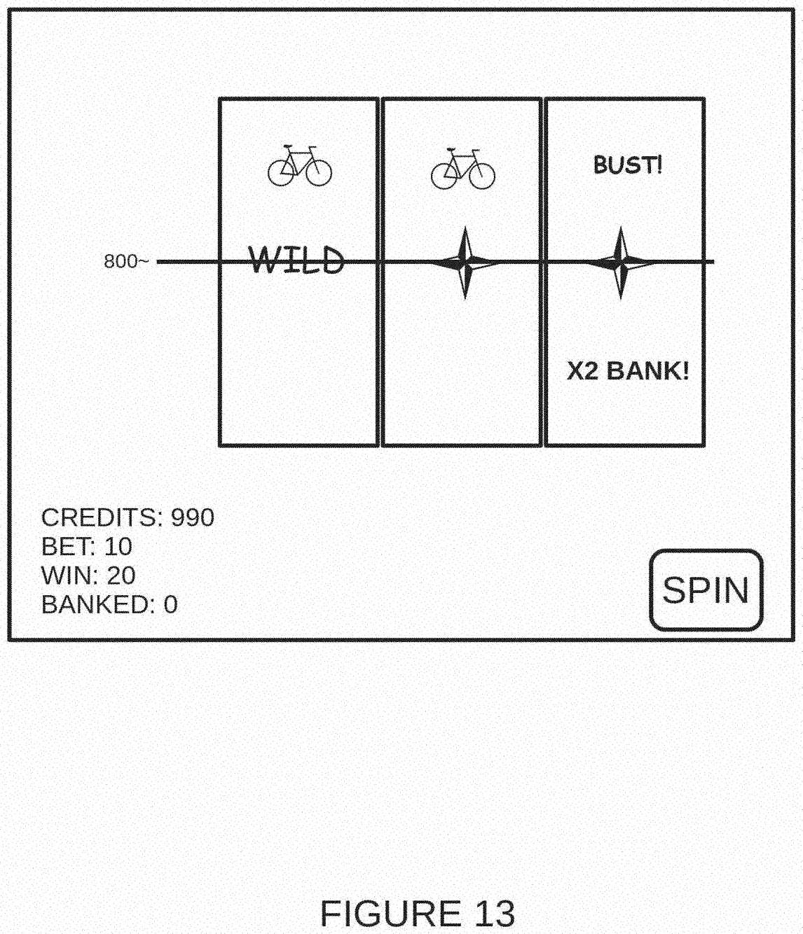

FIG. 13 is a drawing of the three reel slot game of FIG. 12 after the take button was pressed, according to an embodiment.

From FIG. 12, the payer presses the “take” button and the 20 credits which were banked are now added to the credit meter (which now totals 110 credits) and number of banked credits is now zero. The “take” button is no longer active because there is no amount in the bank (“banked” quantity or “banked meter”) left to take. The player can press spin to continue playing (another spin will deduct another 10 credits from the player's number of credits).

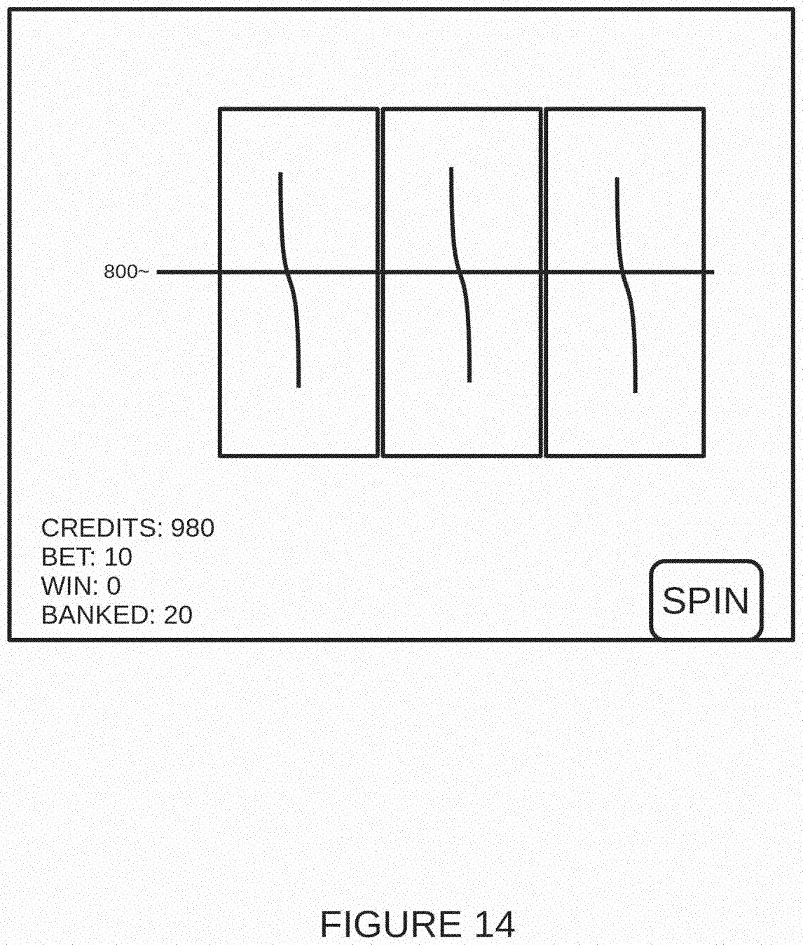

FIG. 14 is a drawing of the three reel slot game of FIG. 12 after the spin button is pressed, according to an embodiment.

Going back to FIG. 12, if the “spin” button is pressed “instead of the “take button”, the reels are spun again. Since the bet amount is 10 credits, the credit meter is dropped by 10 credits to 980. The banked amount (20) remains in the bank.

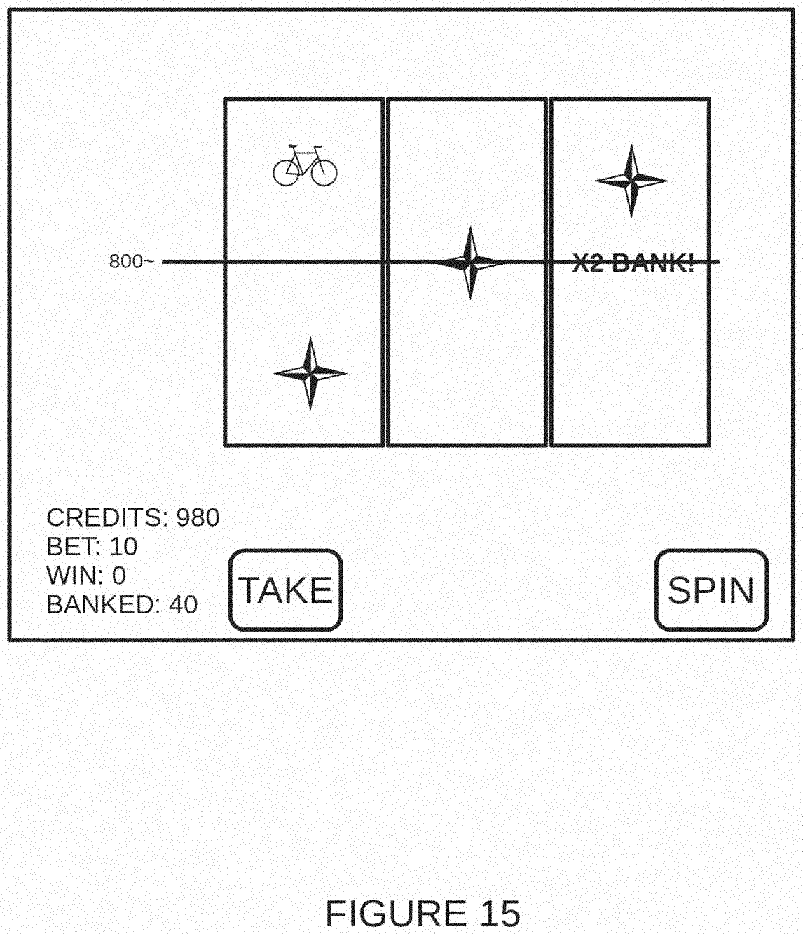

FIG. 15 is a drawing of the three reel slot game of FIG. 14, after the reels stop, according to an embodiment;

The resulting combination after the spin is blank/star/X2 bank!. This is not a winning combination on the paytable (see Table II) if you do not include bank operations. However, this combinations triggers (from Table II) the bank operation “X2” which doubles the amount of credits in the bank. Since the amount previously in the bank was 20 credits, this is now doubled to 40 credits. The player now has the choice to press the “take” button and transfer the 40 banked credits to the credit meter, or press the “spin” button and continue to play while risking the 40 credits in the bank.

Note that if the “BUST!” symbol appears on the payline 800 instead of the “X2 Bank” (as shown in FIG. 15), then the number of credits in the bank would be reduced to zero (and the amount of credits in the credit meter would remain the same). In other words, if the “Bust!” bank operation is triggered, the amount in the bank is set to zero (lost by the player) without any transfer of the bank to the credit mater (which would remain the same as before the bust bank operation).

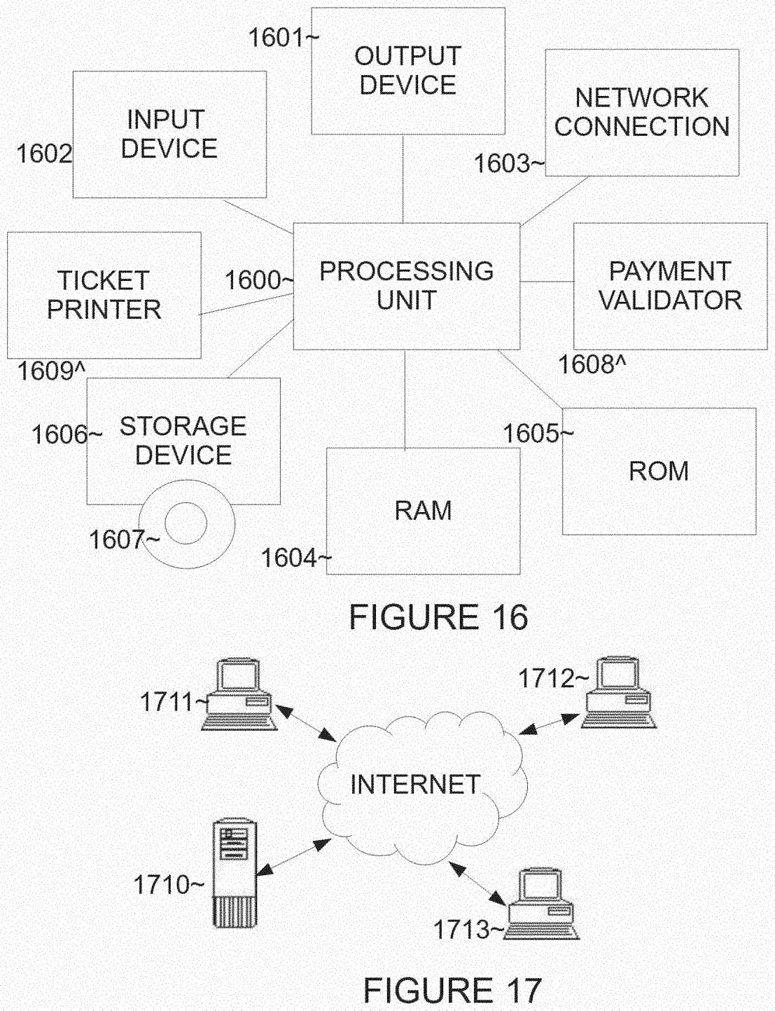

FIG. 16 is a block diagram illustrating exemplary hardware that can be used to implement the game described herein, according to an embodiment. The hardware in FIG. 16 can be used to implement a computer implementing the game described herein and/or a server that is serving the game to a computer which is displaying the game to a player. Such a server can interface with a social networking site (e.g., FACEBOOK, MYSPACE, etc.) that is used to coordinate the entire game and communicate with the players as well as a server used by the social network site. The hardware can also be, for example, an electronic gaming machine (EGM) used in casinos such as a video slot machine. The hardware can also be a personal computer or personal computing device (e.g., laptop, desktop, cell phone, tablet, etc.) playing the game using the Internet. The hardware can also be any other type of device, working individually or in conjunction with other devices.

A processing unit 1600 (such as a microprocessor and any associated components) is connected to an output device 1601 (such as an LCD monitor, touch screen, CRT, etc.) which is used to display to the player any aspect/output/state of the method, and an input device 1602 (e.g., buttons, a touch screen, a keyboard, mouse, etc.) which can be used to input from the player any decision/input made by the player. All methods described herein can be performed by the processing unit 1600 by loading and executing respective instructions which are programmed accordingly. Multiple such processing units can also work in collaboration with each other (in a same or different physical location). The processing unit 1600 can also be connected to a network connection 1603, which can connect the electronic gaming device to a computer communications network such as the Internet, a LAN, WAN, etc. The processing unit 1600 is also connected to a RAM 1604 and a ROM 1605. The processing unit 1600 is also connected to a storage device 1606 which can be a disk drive, DVD-drive, CD-ROM drive, flash memory, etc. A non-transitory computer readable storage medium 1607 (e.g., hard disk, CD-ROM, etc.), can store a program which can control the electronic device to perform any of the methods described herein and can be read by the storage device 1606 and written to by the storage device 1606.

The processing unit 1600 can also be connected to a payment validator 1608. The payment validator can be a bill acceptor which accepts currency, identifies it as being valid (typically by using an optical scanner), and then credits the inserted bill amount to the machine (for example inserting a $10 bill will credit the machine with $10 in credits). These credits can be used to play the games (e.g., pay for a spin). The bill acceptor can also accept cashless tickets as part of a “ticket-in-ticket-out” system, in which tickets (cashless vouchers) have cash value and can be inserted into the payment validator 1608. The validator 1608 validates the ticket (typically be optically scanning a bar-code), communicating electronically with a casino database to verify the ticket is authentic, and once authenticated then crediting the machine with the respective amount of credits. The payment validator 3508 can also include a card reader which can read cards (e.g., with a magnetic stripe or other electronic encoding) so that an account number can be accessed. The cards can be a credit card, player loyalty card, specific casino payment card, or any card that can provide electronic access to a monetary amount owned by the player (owner of the card) which the player can utilize for depositing money and then playing the machine. If such a card is used, then the player can optionally enter (using a keypad) an amount the player wishes to withdraw from the account associated with the card to credit to the machine. The player can also the card in this matter to request that the machine electronically transfer any credits on the machine (e.g., win credits) to the player's account associated with the card.

The processing unit 1600 can also be connected to a ticket printer 1609 which can print tickets (cashless vouchers). When the player cashes out on the machine (indicated to the machine that the player wishes to cash out and terminate by, typically by pressing a button), a ticket is printed by the ticket printer 1609 which carries the amount of credits left on the machine. This ticket can then be used to play other machines in the casino by inserting them into that machine's payment validator. The ticket can also be used to redeem for cash by inserting it into a ticket redemption machine (kiosk) which receives a ticket, validates it (typically by scanning the barcode), and then dispenses an identical amount of cash to what the ticket's value is.

While one processing unit is shown, it can be appreciated that one or more such processor (processing units) can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

Note that if the embodiments described herein are implemented as an electronic gaming machine (EGM) then it may be necessary for the machine to be approved by the regulatory authorities (e.g., the Nevada State Gaming Commission) to ensure they have a suitable return to player (RTP) and are honest. Such approval includes inspection of the hardware, software, play-testing, evaluation of the random number generators (either hardware or software), etc. Once the machine has been approved from a rigorous testing will it be officially approved by a regulatory authority and then can appear in that jurisdictions gaming floor.

FIG. 17 is a network diagram showing a network structure for an online casino and players, according to an embodiment.

A computer communications network (such as the Internet) can be used to connect an online casino server 1710 which can host and serve an online casino and implement a game as described herein via the internet. Note that while FIG. 17 shows only one online casino server 1710, the casino server 3710 can encompass numerous servers all cooperating with each other (whether in the same physical location or not). The casino server 3710 communicates with players 1711, 1712, 1713 through the Internet (or other computer communication network) and can remotely implement any of the methods/games described herein by executing computer code programmed accordingly. As such, the methods/games described herein can be offered at an online casino for credits which are exchangeable for real money.

All components herein can be distributed across different such components as needed. For example, a single server as mentioned herein can be distributed across numerous different servers and locations. A processor (or processing unit) can also be distributed across multiple processors in a same or different computer (at a same or different location). The electronic components described herein represent an abstraction but it can be appreciated that the computer systems implementing the methods herein can be more numerous and interconnected than illustrated herein.

If a player is playing the game described herein on a social networking site or other type of hosted environment, then the player's computer would cooperate with the social networking server in order to present the game to the player. The player's computer would perform the instructions necessary to display the game while the remote server can determine the results (e.g., the final arrangement) and communicate this result via the Internet to the player's computer so that the player's computer can accurately display the result. The remote server may track and account for all credits wagered and won/lost while the player's computer can display the amount of credits owned or won at the direction of the remote server so the player cannot tamper with these amounts. All games described herein are considered to be played on the site described herein.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus to implement a game, the apparatus comprising:
an electronic output device and an electronic input device;
an electronic storage device configured to read a non-transitory computer readable storage medium which stores computer readable instructions;
at least one processing unit connected to the electronic output device, the electronic input device, and the electronic storage device, the at least one processing unit configured to utilize the electronic storage device to read and execute the computer readable instructions which are programmed to cause the at least one processing unit to:
provide a paytable comprising a set of static awards not based on a bank amount and a set of dynamic awards based on a bank amount, wherein the set of dynamic awards comprises a bust which resets an amount of banked credits to zero and a multiplier which multiplies the amount of banked credits by the multiplier wherein the multiplier is an integer greater than 1;
implement a game which comprises:
display a credit meter indicating an amount of credits the player possesses and a bank meter indicating the amount of banked credits;
receive a wager from a player deducted from a credit meter;
spin at least one reel to a random result;
determine a payout based on the random result using the paytable;
award the payout to the bank meter by increasing the amount of banked credits by the payout;
offer the player an option to exercise a player selected option out of an option set, the option set comprising 1) play the game again, and 2) take the banked credits which adds the amount of banked credits to the credit meter and resets the amount of banked credits to zero.

2. The apparatus as recited in claim 1, wherein the computer readable instructions are further programmed such that after the player exercises the take the banked credits, the player is enabled to play the game again.

3. The apparatus as recited in claim 1, wherein the at least one reel is virtual.

4. The apparatus as recited in claim 1, wherein the at least one reel is physical.

5. The apparatus as recited in claim 1, wherein the computer readable instructions are further programmed such that the at least one reel consists of exactly one reel.

6. The apparatus as recited in claim 1, wherein the computer readable instructions are further programmed such that the at least one reel consists of exactly three reels.

7. The apparatus as recited in claim 1, wherein the computer readable instructions are further programmed such that the at least one reel consists of exactly five reels.

8. The apparatus as recited in claim 1, wherein the computer readable instructions are further programmed such that the player is enabled to cash out the amount of credits in the credit meter at any time.

9. The apparatus as recited in claim 1, wherein the computer readable instructions are further programmed such that the player is not allowed to cash out the amount of banked credits.

10. The apparatus as recited in claim 1, wherein after the spin at least one reel, a bonus round is implemented to determine the payout.

11. A method to implement a game, the method comprising:
providing an electronic output device and an electronic input device;
providing an electronic storage device configured to read a non-transitory computer readable storage medium which stores computer readable instructions;
providing at least one processing unit connected to the electronic output device, the electronic input device, and the electronic storage device;
executing the computer readable instructions by the at least one processing unit which cause the at least one processing unit to perform:
providing a paytable comprising a set of static awards not based on a bank amount and a set of dynamic awards based on a bank amount, wherein the set of dynamic awards comprises a bust which resets an amount of banked credits to zero and a multiplier which multiplies the amount of banked credits by the multiplier wherein the multiplier is an integer greater than 1;
implementing a game which comprises:
displaying a credit meter indicating an amount of credits the player possesses and a bank meter indicating the amount of banked credits;
receiving a wager from a player deducted from a credit meter;
spinning at least one reel to a random result;
determining a payout based on the random result using the paytable;
awarding the payout to the bank meter by increasing the amount of banked credits by the payout;
offering the player an option to exercise a player selected option out of an option set, the option set comprising 1) play the game again, and 2) take the banked credits which adds the amount of banked credits to the credit meter and resets the amount of banked credits to zero.

12. The method as recited in claim 11, further comprising, after the player exercises the take the banked credits, enabling the player to play the game again.

13. The method as recited in claim 11, wherein the at least one reel is virtual.

14. The method as recited in claim 11, wherein the at least one reel is physical.

15. The method as recited in claim 11, wherein the at least one reel consists of exactly one reel.

16. The method as recited in claim 11, wherein the at least one reel consists of exactly three reels.

17. The method as recited in claim 11, wherein the at least one reel consists of exactly five reels.

18. The method as recited in claim 11, further comprising enabling the player is enabled to cash out the amount of credits in the credit meter at any time.

19. The method as recited in claim 11, wherein the player is not allowed to cash out the amount of banked credits.

20. The method as recited in claim 11, wherein after the spin at least one reel, implementing a bonus round to determine the payout.
